(19) United States
(12) Patent Application Publication
(10) Pub. No.: US 2025/0261786 A1
(43) Pub. Date: Aug. 21, 2025

(54) Milk Frothing Device And Corresponding Beverage Dispensing Machine

(71) Applicant: SEB S.A., Ecully (FR)

(72) Inventors: Thierry Dutertre, Ecully Cedex (FR); Sylvain Vaugeois, Ecully Cedex (FR)

(73) Assignee: SEB S.A., Ecully (FR)

(21) Appl. No.: 19/057,532

(22) Filed: Feb. 19, 2025

(30) Foreign Application Priority Data
Feb. 21, 2024 (FR) FR2401718

(51) Int. Cl. A47J 31/44

(52) U.S. Cl. CPC A47J 31/4489

(57) ABSTRACT

A milk frothing device includes a tank and a mixing element configured to be removably attached to the tank including. The mixing element includes a first locking member that can be moved between a locked position and an unlocked position. The mixing element also includes at least a second locking member configured to engage with a respective second fastening slot formed on the tank.

### TECHNICAL FIELD

The present invention relates to the field of beverage dispensing machines and particularly coffee machines, preferably automatic coffee machines. More specifically, the present invention relates to the field of milk frothing devices designed to work in conjunction with beverage dispensing machines such as coffee machines. Such frothing devices, in particular when combined with a coffee machine, make it possible to prepare beverages from coffee and frothed milk.

### Technical Description

Document CN210989735 U discloses a milk frothing device in the form of a milk jug comprising of a milk tank and a mixing element designed to be attached to the tank. In CN210989735 U the mixing element comprises of a system for attaching the mixing element to the tank in the form of a movable locking member designed to engage with a corresponding slot formed on the tank.

However, the frothing device according to CN210989735 U is nonetheless complex and its ergonomics, robustness, cleanability and dismantling still need to be improved.

### SUMMARY OF THE INVENTION

This invention aims to remedy these disadvantages.

The technical problem behind the invention is to provide a simplified milk frothing device that is easier to use, more robust and easier to disassemble.

To this end, the invention relates to a milk frothing device comprising of a milk tank comprising of an opening, and a mixing element, the mixing element being designed to be removably attached to the tank at the opening and comprising of a system for attaching it to the tank, the attachment system comprising of a first locking member that can be moved between a locked position, in which the first locking member is designed to be received in a first fastening slot formed on the tank, and an unlocked position, in which the first locking member is designed to be extracted from the first fastening slot. According to the invention, the attachment system also comprises of at least one additional locking member designed to engage with a respective additional fastening slot formed on the tank.

With this invention, the mixing element is easier to handle and its attachment to the tank is improved. Indeed, the additional locking member allows for the simple and improved attachment of the mixing element to the tank, thereby guaranteeing good frothing performance and robustness of the frothing device. Moreover, the first locking member and each additional locking member allow for simple attachment/separation of the mixing element from the tank for improved dismantling and use. In particular, simplifying the separation of the mixing element and the tank enables the user to clean these components easily.

According to advantageous but non-mandatory aspects of the invention, such a frothing device can incorporate one or more of the following features, taken in any technically permissible combination.

According to an advantageous feature of the invention, when the first locking member is moved between the locked and unlocked positions, the first locking member can be moved relative to each additional locking member.

According to an advantageous feature of the invention, the tank extends substantially along a central axis that is substantially vertical when the milk frothing device is in use, and the first locking member is moved from the locked position to the unlocked position in a direction of travel that is substantially perpendicular to the central axis and extends from the first locking member to each additional locking member so that the distance between the first locking member and each additional locking member is reduced.

According to an advantageous feature of the invention, each additional locking member is mechanically associated with the first locking member so that moving the first locking member between the locked and unlocked positions results in a corresponding movement of each additional locking member between a locked position in which the additional locking member is designed to be received in the respective additional fastening slot, and an unlocked position in which the additional locking member is designed to be extracted from the respective additional fastening slot.

This design allows for easy handling of the attachment system and therefore easy separation of the mixing element from the tank, while at the same time providing a reliable and robust attachment system guaranteeing user safety and good milk frothing performance.

According to an advantageous feature of the invention, the attachment system comprises of, for each additional locking member, an arm that can be rotated relative to the first locking member as it moves between the locked and unlocked positions, each arm being designed, as it rotates, to translationally drive the corresponding additional locking member so as to move it between the locked position and the unlocked position.

This design allows for efficient transmission of the movement from the first locking member to each additional locking member and thus makes it easier to handle the attachment system and separate the mixing element from the tank.

According to an advantageous feature of the invention, the first locking member is moved from the locked position to the unlocked position in a direction of travel extending from the first locking member to the additional locking members so that the distance between the first locking member and each additional locking member is reduced, and when the first locking member is moved from the locked position to the unlocked position, each arm is designed to move the corresponding additional locking member towards the first locking member.

This design provides a compact and robust attachment system.

According to an advantageous feature of the invention, each arm comprises of a first pivot connection with the first locking member and a second pivot connection with the corresponding additional locking member, the first and second pivot connections being positioned at opposite ends of the corresponding arm.

This design allows for efficient transmission of movement from the first locking member to each additional locking member.

According to an advantageous feature of the invention, for each arm the first and second pivot connections respectively define substantially parallel first and second rotational axes extending in a substantially vertical direction.

This design provides a compact and robust attachment system.

According to an advantageous feature of the invention, the mixing element comprises of a main body and each arm comprises of an additional pivot connection with the main body, the additional pivot connection being positioned between the first and second pivot connections.

This design ensures that the attachment system is secured to the main body and therefore the mixing element.

According to an advantageous feature of the invention, the mixing element comprises of a main body and the main body comprises of, for each additional locking member, an additional projection designed to form a slide connection with the additional locking member.

This design allows each additional locking element to move freely between locked and unlocked positions and ensures that the attachment system is secured to the main body and thus to the mixing element.

According to an advantageous feature of the invention, the first locking member forms a bearing surface on which a force can be exerted to move the first locking member from its locked position to its unlocked position.

This design allows for easy handling of the attachment system and therefore easy separation of the mixing component from the tank.

According to an advantageous feature of the invention, the first locking member has a corresponding lock position return member.

This design ensures that the attachment system, and therefore the first locking member as well as each additional locking member, are kept in the locked position when no force is applied to the attachment system. The locking position is therefore the rest position of the attachment system.

According to an advantageous feature of the invention, the first locking member has a sloping edge forming a chamfer designed to engage with an upper edge of the opening when the mixing element is mounted on the tank, to move the first locking member to the unlocked position.

This design makes it easier to mount the mixing element on the tank.

According to an advantageous feature of the invention, each additional locking member has a sloping edge forming a chamfer designed to engage with an upper edge of the opening when the mixing element is mounted on the tank, to move each additional locking member to the unlocked position.

This design makes it easier to mount the mixing element on the tank.

According to an advantageous feature of the invention, the mixing element comprises of a mixing part, a hot water/steam inlet port and a main flow duct connecting the hot water/steam inlet port to the mixing part.

This design enables frothed milk to be prepared using the frothing device.

According to an advantageous feature of the invention, the mixing element comprises of a main body comprising of the mixing part, the hot water/steam inlet port, the main flow duct and a milk feed duct connected to the main flow duct, and a main body cover member that can be moved relative to the main body between a closed position in which the cover member closes and/or covers the mixing part and the main flow duct, and an open position in which the mixing part and the main flow duct are open and accessible to allow the mixing part and the main flow duct to be cleaned.

This design makes it easier to clean the mixing element and prepare frothed milk with the frothing device.

The invention also aims to provide a beverage dispensing machine comprising of a hot water/steam dispensing nozzle and a milk frothing device designed to be connected to the hot water/steam dispensing nozzle. According to the invention, the milk frothing device is as described above.

This design enables the beverage dispensing machine to be used to prepare beverages made from frothed milk simply and with improved robustness and ease of use. Indeed, the attachment system makes it easy to mount/remove the frothing device and ensures optimal attachment of the mixing element to the tank, thereby improving the reliability of the frothing device.

### BRIEF DESCRIPTION OF THE FIGURES

The purposes, aspects and advantages of the present invention, according to the description given below of a particular embodiment of the invention presented by way of non-limiting example, will be better understood by referring to the attached drawings in which:

FIG. 1 is a very schematic representation of a beverage dispensing machine equipped with a milk frothing device according to one embodiment of the invention;

FIG. 2 is a perspective view of the frothing device in FIG. 1 comprising of a milk tank and a mixing element with the system for attaching it to the tank in a locked position;

FIG. 3 is a similar view to FIG. 2 from another point of view;

FIG. 4 is a similar view to FIG. 2, with the attachment system in the unlocked position;

FIG. 5 is an exploded view of the frothing device in FIG. 2;

FIG. 6 is a perspective view of the attachment system in FIG. 2 in the locked position;

FIG. 7 is a perspective view of the attachment system in FIG. 4 in the unlocked position.

Only those elements required in order to understand the invention have been depicted. In order to facilitate the interpretation of the drawings, the same elements are labeled with the same references across all the figures.

### DETAILED DESCRIPTION OF THE INVENTION

In the remainder of this description, froth or frothing is understood to mean producing a froth from a liquid, whether only the froth of this liquid (i.e., milk froth) or a blend of this liquid and the froth of this liquid (i.e., a blend of milk and milk froth).

It will be noted that in this document, the terms “horizontal,” “vertical,” “lower,” “upper,” “top,” “bottom,” “front,” “rear,” “longitudinal” and “transverse” used to describe the beverage dispensing machine and its corresponding elements refer to the beverage dispensing machine and its corresponding elements when in use, sitting flat on a countertop.

In addition, the terms “upstream” and “downstream” or “inlet” and “outlet” are defined in relation to a flow direction of the beverage or of the steam in the beverage dispensing machine and in the milk frothing device.

The terms “external” and “internal” as well as the terms “outer” and “inner” are defined relative to a central axis of the beverage dispensing machine or of the milk frothing device. Therefore an internal/inner portion/part will be closer to the central axis than an external/outer portion/part.

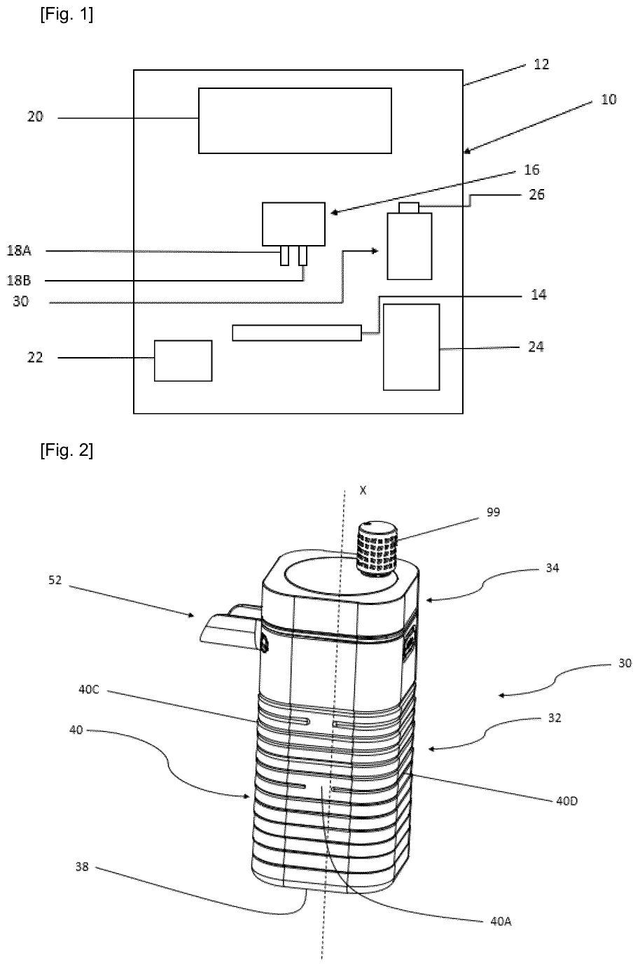

The beverage dispensing machine shown in FIG. 1 is a coffee machine 10. As a variant, the beverage dispensing machine is a hot water or tea dispensing machine.

The coffee machine 10, shown very schematically in FIG. 1, is advantageously an automatic coffee machine 10.

The coffee machine 10 comprises of a frame 12, a container stand 14 on which a container can be placed, and a beverage dispensing head 16. The beverage dispensing head 16 comprises of at least one, preferably two, coffee dispensing nozzles 18A, 18B.

The coffee machine 10 comprises of a control circuit 20 for managing the preparation of a beverage based on the instructions given by a user. The coffee machine 10 also comprises of a boiler 22 producing hot water and/or steam and a tank 24 for holding cold water. The tank 24 supplies boiler 22 to produce hot water and/or steam.

The coffee machine 10 also comprises of a hot water/steam dispensing nozzle 26 designed to be supplied with hot water and/or steam from boiler 22.

In a conventional manner not shown, the coffee machine 10 advantageously comprises of a coffee bean reservoir, an automatic bean grinder and a brewing chamber designed to receive the ground coffee beans and to be supplied with hot water by boiler 22. The brewing chamber is fluidly connected to the dispensing head 16 such that the coffee machine 10 is designed to dispense a beverage made with coffee from the coffee dispensing nozzles 18A, 18B.

According to the invention, the coffee machine 10 also comprises of a milk frothing device 30 designed to be connected to the hot water/steam dispensing nozzle 26.

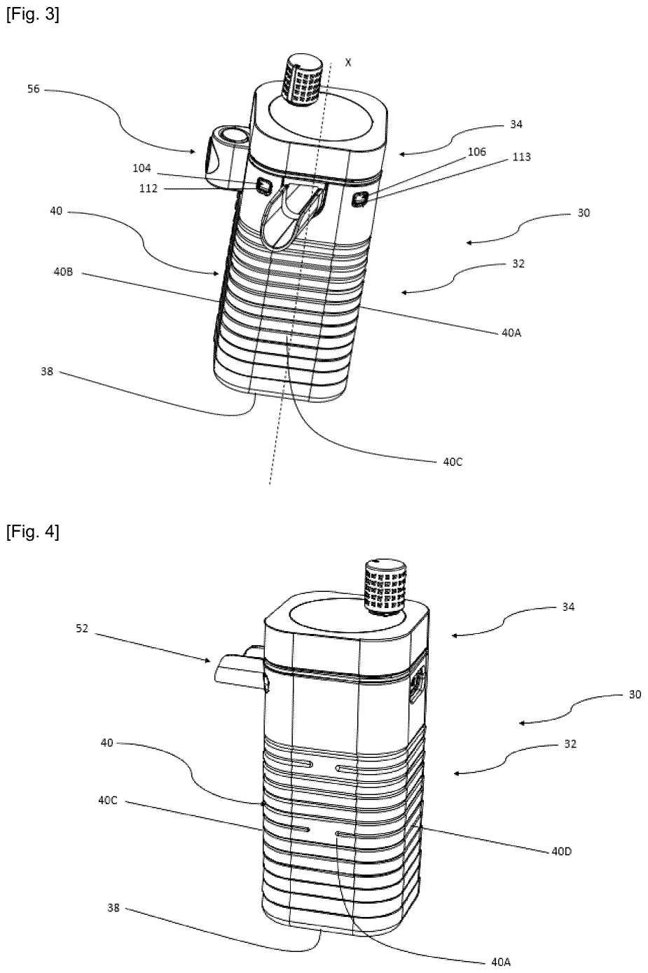

As shown in FIGS. 2 to 5, the milk frothing device 30 comprises of a milk tank 32, a mixing element 34 designed to be attached to the tank 32 and a milk feed tube 35 for the mixing element 34 designed to extend between the tank 32 and the mixing element 34.

The tank 32 is designed to receive milk to be frothed using the mixing element 34, which forms a frothing member.

The tank 32 delimits an inner volume designed to contain milk and comprising of an opening 36, preferably at the top.

For example, the tank 32 is generally cylindrical in shape and comprises of a base 38 and a circumferential wall 40 extending upwards from the base 38. For example, the circumferential wall 40 forms a front side 40A, a rear side 40B, a left side 40C and a right side 40D.

The tank 32 extends substantially along a central axis X that is substantially vertical when the milk frothing device 30 is in use, in particular when connected to the hot water/steam dispensing nozzle 26.

The opening 36 is advantageously an opening for filling the tank 32.

The bottom 38 and the circumferential wall 40 together form the inner volume.

The tank 32 comprises of a first fastening slot 42 for attaching the mixing element 34 to the tank 32. The first fastening slot 42 is formed on the circumferential wall 40.

The tank also comprises of two additional fastening slots 46, 48 for attaching the mixing element 34 to the tank 32. Namely, a first additional fastening slot 46 and a second additional fastening slot 48.

As a variant, the tank comprises of a single additional fastening slot or more than two additional fastening slots.

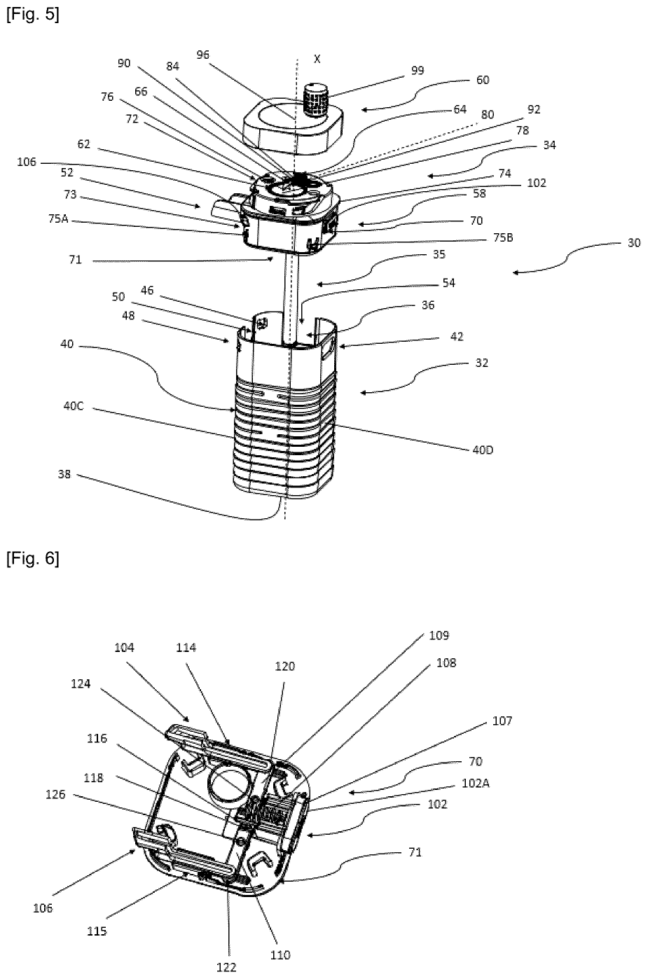

Advantageously, as shown in FIG. 5, the additional fastening slots 46, 48 are positioned opposite the first fastening slot 42. In other words, the additional fastening slots 46, 48 on the one hand and the first fastening slot 42 on the other hand are arranged on two opposite sides of the circumferential wall 40. For example, the additional fastening slots 46, 48 are arranged on the left-hand side 40C, and the first fastening slot 42 is arranged on the right-hand side 40D.

Advantageously, the first fastening slot 42 and the additional fastening slots 46, 48 are pass-through in a direction substantially radial to the central axis X.

Advantageously, the tank 32 also forms a receiving slot 50 for a frothed milk dispensing member 52, such as a spout, arranged for example on the left-hand side 40C between the two additional fastening slots 46, 48.

Also advantageously, the tank 32 forms a receiving slot 54 for a member 56 for reversibly connecting the milk frothing device 30 to the hot water/steam dispensing nozzle 26.

The receiving slot 54 is shown in FIG. 5 and is formed, for example, on the rear side 40B.

The mixing element 34 is arranged in the opening 36.

The mixing element 34 is designed to be removably attached to the tank 32 at the opening 36 and advantageously to close the opening 36.

The mixing element 34 forms a frothing member and comprises of, as shown in FIG. 5, a main body 58 and a cover member 60 for the main body 58.

When attached to the tank 32, the main body extends along a central axis corresponding to the central axis X of the tank. In the remainder of the description and the drawings, the central axis of the main body 58 coincides with the central axis of the tank 32.

The main body 58 comprises of a mixing part 62, a hot water/steam inlet port 64 and a main flow duct 66 connecting the hot water/steam inlet port 64 to the mixing part 62.

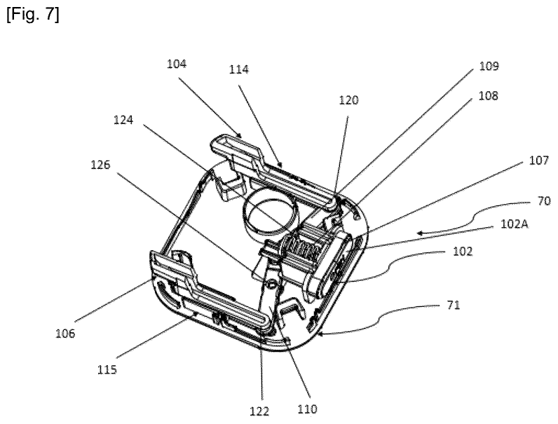

The main body 58 comprises of a reversible attachment system 70 for attaching the mixing element 34 to the tank 32, more clearly shown in FIGS. 6 and 7.

The main body 58 advantageously comprises of the frothed milk dispensing member 52, which is fluidly connected to the mixing part 62. The frothed milk dispensing member 52 is designed to be positioned in the receiving slot 50.

The main body 58 also advantageously comprises of the member 56 for connecting the milk frothing device 30 to the hot water/steam dispensing nozzle 26.

The connecting member 56 opens onto a rear side of the frothing device 30 and is designed in particular to be received in the receiving slot 54 formed on the rear side 40B of the tank 32. When the frothing device 30 is combined with the coffee machine 10, the connecting member 56 is designed to be connected to the hot water/steam dispensing nozzle 26 so that it can be supplied with hot water/steam. The connecting member 56 is configured to attach/connect the frothing device to the coffee machine 10 and in particular to the hot water/steam dispensing nozzle 26.

The hot water/steam inlet port 64 is fluidly connected to the connecting member 56 so that it receives hot water/steam delivered by the hot water/steam dispensing nozzle 26 when the connecting member 56 is connected to the hot water/steam dispensing nozzle 26.

The main body 58 is designed to cover and close the opening 36 and comprises of a lower wall 71, an upper wall 72 and a circumferential wall 73.

In particular, the main body 58 comprises of a shoulder 74 designed to engage an edge of an upper end of the tank 32 when the mixing element 34 is attached to the tank 32.

Advantageously, the main body 58 comprises of members 75A, 75B that bear against an inner side of the circumferential wall 40 shown in FIG. 5. The bearing members 75A, 75B are designed to exert a radial bearing force against the inner side of the circumferential wall 40 to provide additional support for the main body 58 and in particular the mixing element 34 on the tank 32. The bearing members 75A, 75B are, for example, elastically deformable tabs arranged on the circumferential wall 73. Only two bearing members 75A, 75B are shown in FIG. 5. Advantageously, the main body comprises of four bearing members evenly distributed along the circumferential wall 73.

The mixing part 62 comprises of a liquid inlet opening 76, a liquid outlet opening, not shown in the figures, and a mixing chamber 78 extending between the liquid inlet opening 76 and the liquid outlet opening.

The mixing chamber 78 extends in a vertical direction parallel to the central axis X when the mixing element 34 is attached to the tank 32.

The mixing chamber 78 comprises of an open upper end 80. The open upper end 80 forms an access opening to the mixing chamber 78.

The mixing chamber 78 opens into an upper side of the upper wall 72 of the main body 58.

The mixing chamber 78 has a substantially circular cross-section perpendicular to the vertical direction.

The liquid inlet opening 76 opens into an upper part of the mixing chamber 78, for example at an upper point of the mixing chamber 78, and the liquid outlet opening is located in a lower part of the mixing chamber 78, for example at a lower point of the mixing chamber 78.

The open top end 80 is arranged on an upper side of the main body 58 and therefore of the upper wall 72.

The liquid outlet opening is fluidly connected to the frothed milk dispensing member 52 so that the frothed milk dispensing member 52 can be supplied with frothed milk via the liquid outlet opening and dispense frothed milk into a cup positioned directly below the frothed milk dispensing member 52.

The main flow duct 66 is arranged in the upper side of the upper wall 72 and opens into the mixing chamber 78 at the liquid inlet opening 76.

The main flow duct 66 opens out substantially tangentially into the mixing chamber 78, such that the mixing chamber 78 is of the cyclone type. Therefore, the liquid flowing into the mixing chamber 78 from the main flow duct 66 flows through the mixing chamber, swirling along the walls of the mixing chamber 78.

As shown in FIG. 5, the main flow duct 66 comprises of a cross-sectional constriction 84 located, for example, in a central portion of the main flow duct 66. In particular, the main flow duct 66 comprises of a first duct portion that is located upstream of the cross-sectional constriction 84 and extends to the cross-sectional constriction, and a second duct portion that is located downstream of the cross-sectional constriction 84 and extends from the cross-sectional constriction 84 to the mixing chamber 78. Advantageously, the first duct portion has a through section that decreases towards the cross-section constriction 84 and the second duct portion has a through section that widens towards the mixing chamber 78.

The hot water/steam inlet port 64 opens into the first duct portion, more specifically opposite the mixing chamber 78. The main flow duct 66 is thus configured to fluidly connect the hot water/steam inlet port 64 to the mixing chamber 78 and to allow a flow of hot water/steam through the main flow duct 66 and into the mixing chamber 78.

The main body 58 also comprises of a milk feed duct 90 connected to the main flow duct 66. When the mixing element 34 is attached to the tank, the milk feed duct 90 extends between the main flow duct 66 and the milk feed tube 35 so that it is fluidly connected to the inner volume of the tank 32.

The milk feed duct 90 is fluidly connected to the main flow duct 66 and therefore configured to be fluidly connected to the mixing chamber 78 via the main flow duct 66.

The milk feed duct 90 comprises of a substantially vertical portion that extends preferably from near the lower wall 71 and opens into the main flow duct 66 at the cross-sectional constriction 84.

In FIG. 5, only the part of the milk feed duct 90 that opens into the main flow duct 66 is shown.

The main body 58 also comprises of an air intake channel 92 in the main flow duct 66.

Advantageously, the air intake channel 92 is arranged in the upper side of the upper wall 72 of the main body 58.

The air intake channel 92 opens into the main flow duct 66 at the cross-sectional constriction 84. The air intake channel 92 is thus configured to be fluidly connected to the mixing chamber 78 via the main flow duct 66.

The previously described cross-sectional constriction 84 increases the speed of the steam flowing through the main flow duct 66, generating a negative pressure in the milk feed duct 90 and in the air intake channel 92. The cross-sectional constriction 84 is therefore more specifically configured to form a milk and air intake system based on the venturi effect. The main flow duct 66 is thus configured so that a flow of hot water/steam through the main flow duct 66 from the hot water/steam inlet port 64 to the mixing chamber 78 generates a negative pressure in the milk feed duct 90 and a negative pressure in the air intake channel 92, and consequently causes milk and air to be drawn into the main flow duct 66 and the drawn milk and air to flow to the mixing chamber 78.

In addition, the second duct portion, which has a through section that widens in the direction of the mixing chamber 78, facilitates a first mixing of the steam, milk and air coming respectively from the hot water/steam inlet port 64, the milk feed duct 90 and the air intake channel 92, before they arrive in the mixing chamber 78.

In addition, by positioning the main flow duct 66 relative to the mixing chamber 78, the first blend of steam, milk and air undergoes a cyclonic movement when it arrives from the mixing chamber and swirls along the walls of the chamber 78, further enhancing the mixing and obtaining a milk froth of optimal consistency. Thus, the mixing chamber 78 enables homogenization of the aforementioned blend and finalization of the mixing begun in the second duct portion.

The main flow duct 66, the hot water/steam inlet port 64, the air intake channel 92 and the mixing chamber 78 advantageously comprise an open upper end. In other words, they form liquid flow channels open to the exterior in their upper part.

The cover member 60 is designed to cover the upper side of the upper wall 72.

The cover member 60 can be moved relative to the main body 58 between a closed position in which the cover member 60 closes and/or covers the mixing part 62 and the main flow duct 66, and an open position in which the mixing part 62 and the main flow duct 66 are open and accessible to allow the mixing part 62 and the main flow duct 66 to be cleaned.

Advantageously, the cover member 60 is designed to be attached to the main body 58 in the closed position and to be separated from the main body 58 in the open position.

The cover member 60 can be attached to the main body 58 via a bayonet-type attachment mechanism shown in FIG. 5.

In the closed position the cover member 60 closes and/or covers, in particular, the open upper end of the hot water/steam inlet port 64, the main flow duct 66 and the mixing chamber 78.

Advantageously, in the closed position, the cover member 60 also at least partially closes and/or covers the air intake channel 92 and in particular the open upper end of the air intake channel.

When in the open position, the cover member 60 allows access to the hot water/steam inlet port 64, the main flow duct 66, the mixing chamber 78 and, advantageously, the channel 92 for cleaning purposes. When in the closed position, it seals the hot water/steam inlet port 64, the main flow duct 66, the mixing chamber 78 and, advantageously, the channel 92.

Advantageously, the cover member 60 forms a substantially flat cover designed to cover the upper side of the upper wall 72 and in particular the mixing part 62 and the main flow duct 66.

The cover member 60 forms a lid on the main body 58 and is designed to be positioned over the opening 36 when the mixing element 34 is attached to the tank 32.

The cover member 60 also comprises of a viewing window 96, designed to be opposite the upper wall 72.

The viewing window 96 is in particular designed to be opposite the mixing part 62, particularly the mixing chamber 78, and advantageously also the main flow duct 66 when the cover member 60 is in the closed position.

The viewing window 96 is designed to be opposite the open upper end 80 when the cover member 60 is in the closed position.

The viewing window 96 is, for example, formed by a portion of the cover member 60 made of a transparent material so that the user can view the inside of the mixing chamber 78 and advantageously the main flow duct 66 when the cover member 60 is in the closed position.

The viewing window 96 allows the user to see whether the frothing device 30 has already been used and whether it needs to be cleaned before making a beverage. In addition, the user can check the correct operation of the frothing device 30 through the viewing window by visually checking whether the milk is flowing through the main flow duct 66 and the mixing chamber 78 and has a cyclonic movement along the walls of the chamber 78.

The cover member 60 also comprises of an air feed duct, not shown in the figures, connected to the air intake channel 92 when the cover member 60 is in the closed position so that it is fluidly connected to the main flow duct 66.

The cover member 60 also comprises of an air flow adjustment device 99 configured to adjust an air flow rate through the air feed duct to the main flow duct 66.

The air feed duct is, for example, an orifice passing through the cover member 60 in the vertical direction when the cover member 60 is in the closed position.

The system 70 for attaching the mixing element 34 to the tank 32 is shown in greater detail in FIGS. 6 and 7. FIGS. 6 and 7 more specifically show the lower wall 71 of the main body, on the inner side of which the attachment system 70 is positioned.

The attachment system 70 comprises of a first locking member 102 designed to engage the first fastening slot 42.

The attachment system 70 also comprises of two additional locking members 104, 106 designed to respectively engage the corresponding additional fastening slot 46, 48.

The first locking member 102 and the additional locking members 104, 106 form latches designed to engage the corresponding fastening slots 42, 46, 48.

The first locking member 102 can be moved between a locked position, shown in FIG. 6, in which the first locking member 102 is designed to be received in the first attachment slot 42 formed on the tank, and an unlocked position, shown in FIG. 7, in which the first locking member 102 is designed to be extracted from the first fastening slot 42.

In the locked position shown in FIG. 6, the first locking member 102 extends in a radial direction relative to the central axis X, protruding from the main body 58 and in particular from the circumferential wall 73 of the main body.

In the unlocked position shown in FIG. 7, the first locking member 102 extends in a radial direction relative to the central axis X, substantially recessed or plumb with the main body 58 and in particular the circumferential wall 73 of the main body.

The first locking member 102 is arranged, for example, at an opening formed through the circumferential wall 73.

The locking position corresponds to a deployed position and the unlocked position to a retracted position.

The first locking member 102 is moved from the locked position to the unlocked position in a direction of travel substantially perpendicular to the central axis X, extending from the first locking member 102 to the additional locking members 104, 106, so that the distance between the first locking member 102 and each additional locking member 104, 106 is reduced.

The first locking member 102 forms a bearing surface 102A on which a force can be exerted by a user to move the first locking member 102 from its locked position to its unlocked position.

The first locking member 102 has a sloping edge forming a chamfer 107 designed to engage with an upper edge of the opening 36 when the mixing element 34 is mounted on the tank 32, to move the first locking member 102 to the unlocked position. The mounting direction is substantially vertical.

Advantageously, the chamfer 107 extends, for example, around the edge of the first locking member 102 and comprises of an outer end closer to the central axis X than an inner end. The outer and inner ends are defined relative to a center of the first locking member. The chamfer is therefore also designed to engage an upper edge of the first fastening slot 42 when removing the mixing element 34 from the tank 32, to move the first locking member 102 to the unlocked position. The removal direction is essentially vertical.

The first chamfer 107 is therefore designed to engage an inner side of the circumferential wall 40 both when mounting and removing the mixing element 34 on or from the tank 32 so that the first locking member 102 is moved to the unlocked position when the first locking member 102 translates along the circumferential wall 40 during the mounting and removal operations.

As a variant, the chamfer 107 extends only on a lower side of the first locking member 102.

The attachment system 70 advantageously comprises of a return member 108 associated with the first locking member 102. The return member 108 is configured to return the first locking member 102 to the locked position. The return member 108 is a spring, for example.

When the main body 58 is mounted on the tank 32, if the first locking member 102 is placed opposite the first fastening slot 42, it is held in the first fastening slot 42 by the return force exerted by the return member 108.

Advantageously, each additional locking member 104, 106 is mechanically associated with the first locking member 102 so that moving the first locking member 102 between the locked and unlocked positions results in a corresponding movement of each additional locking member 104, 106 between a locked position in which the additional locking member 104, 106 is designed to be received in the respective additional fastening slot 46, 48, and an unlocked position in which the additional locking member 104, 106 is designed to be extracted from the respective additional fastening slot 46, 48.

For each additional locking member 104, 106, the attachment system 70 comprises of, for example, an arm 109, 110 that can be rotated relative to the first locking member 102 as it moves between the locked and unlocked positions.

In the locked position, each additional locking member 104, 106 extends in a radial direction relative to the central axis X, protruding from the main body 58 and in particular from the circumferential wall 73 of the main body.

In the unlocked position, each additional locking member 104, 106 extends in a radial direction relative to the central axis, substantially recessed or plumb with respect to the main body 58 and in particular the circumferential wall 73 of the main body.

Each additional locking member 104, 106 is arranged, for example, at a corresponding opening formed through the circumferential wall 73.

The locking position corresponds to a deployed position and the unlocked position to a retracted position.

Each additional locking member 104, 106 also has a sloping edge forming a chamfer 112, 113 designed to engage with an upper edge of the opening 36 when the mixing element 34 is mounted on the tank 32, to move the additional locking member 104, 106 to the unlocked position.

Advantageously, each chamfer 112, 113 extends only on a lower side of the corresponding additional locking member 104, 106. Each chamfer 112, 113 comprises of an outer end closer to the central axis X than an inner end. The outer end and the inner end are defined relative to a center of the corresponding additional locking member 104, 106.

Each arm 109, 110 is designed, as it rotates, to translationally drive the corresponding additional locking member 104, 106 in order to move it between the locked position and the unlocked position.

Advantageously, the main body 58 comprises of, for each additional locking member 104, 106, an additional relief 114, 115 designed to form a slide connection with the additional locking member 104, 106.

When the first locking member 102 is moved from the locked position to the unlocked position, each arm 109, 110 is designed to move the corresponding additional locking member 104, 106 in the direction of the first locking member 102.

When the first locking member 102 is moved from the unlocked position to the locked position, in particular under the effect of the return member 108, each arm 109, 110 is designed to move the corresponding additional locking member 104, 106 away from the first locking member 102.

Each arm 109, 110 comprises of a first pivot connection 116, 118 with the first locking member 102 and a second pivot connection 120, 122 with the corresponding additional locking member 104, 106.

Advantageously, each first pivot connection 116, 118 is formed by an axial protrusion extending in the vertical direction from the first locking member 102 and a hole, preferably oblong, formed in the corresponding arm.

Advantageously, each second pivot connection 120, 122 is formed by an axial protrusion extending in the vertical direction from the corresponding additional locking member 104, 106 and a hole formed in the corresponding arm.

For each arm 109, 110, the first 116, 118 and second 120, 122 pivot connections are positioned at opposite ends of the corresponding arm 109, 110.

For each arm 109, 110, the first 116, 118 and second 120, 122 pivot connections respectively define substantially parallel first and second rotational axes extending in a substantially vertical direction.

Each arm 109, 110 comprises of an additional pivot connection 124, 126 with the main body 58 and in particular the lower wall 71. The additional pivot connection 124, 126 is positioned between the first 116, 118 and second 120, 122 pivot connections.

The additional pivot connection 124, 126 attaches the corresponding arm 109, 110 to the mixing element 34 and in particular to the main body 58.

Each additional pivot connection 124, 126 is formed, for example, by a hinge pin, not shown, extending from an upper part of the main body 58 through a corresponding hole formed through the arm 109, 110 and into a slot formed on an inner side of the lower wall 71.

Advantageously, the main body 58 and in particular the lower wall 71 comprise stops designed to limit the movement of the locking members 102, 104, 106 between the locked and unlocked positions, therefore forming the locked and unlocked positions.

The operation of the frothing device 30 and in particular the attachment system 70 for making a frothed milk beverage will be explained below using the figures.

In a first step, the tank 32, the mixing element 34 and the milk feed tube 35 are provided to a user.

In a next step, the user connects the milk feed tube 35 to the main body 58, then fastens the cover member 60 to the main body 58.

Then, in an assembly step, the user positions the mixing element 34 on the tank 32, installing the milk feed tube 35 in the inner volume. During the assembly step, the main body 58 is positioned at the opening 36 and translates downwards relative to the tank 32. The chamfers 107, 112, 113 that bear against an inner side of the circumferential wall 40, so that the locking members 102, 104, 106 are moved from the locked position to the unlocked position. Then, at the end of the translational movement, the locking members 102, 104, 106 are positioned opposite the corresponding fastening slots 42, 46, 48 and are then moved from the unlocked position to the locked position under the effect of the return member 108 so that they are positioned through the fastening slots 42, 46, 48.

Following the assembly step, the user can connect the frothing device to the coffee machine 10 and in particular the connecting member 56 to the hot water/steam dispensing nozzle 26, so that beverages prepared with frothed milk can be made, the frothed milk being dispensed via the frothed milk dispensing member 52.

When making a beverage, the user can check that the frothing device 30 is working properly via the viewing window 96, and adjust the air flow delivered to the air intake channel 92 using the air flow adjustment device 99.

Once the frothed milk beverage has been made, the user disconnects the connecting member 56 from the hot water/steam dispensing nozzle 26.

Then, in a removal step, the user exerts an opposing force on the bearing surface 102A of the first locking member 102, so that the locking members 102, 104, 106 move from the locked position to the unlocked position. During the removal step, the locking members 102, 104, 106 are extracted from the fastening slots 42, 46, 48. The user then exerts an upward translational movement on the mixing element and the locking members are kept in the unlocked position by contact with the inner side of circumferential wall 40.

At the end of the removal step, the mixing element 34 is separated from the tank 32 by simply pressing on the first locking member 102 and performing a translational movement.

The user then separates the cover member 60 from the main body 58 and can put the various elements in the dishwasher for cleaning.

This new invention makes the ergonomics and handling of the milk frothing device 30 easier. In addition, cleaning is made easier and the robustness of the attachment of the elements making up the frothing device 30 is improved.

As a variant, the attachment system comprises of a single additional locking member or more than two additional locking members.

As shown in the figures, when moving the first locking member between the locked and unlocked positions, the first locking member 102 can be moved between each additional locking member 104, 106. In other words, when the first locking member is moved between the locked and unlocked positions, the first locking member 102 can be moved relative to each additional locking member, and in particular towards or away from each additional locking member.

Of course, the present invention is in no way limited to the embodiment described and illustrated, since this embodiment was only provided by way of example. Changes can still be made, particularly with regard to the constitution of the various elements or by substituting technical equivalents, without departing from the scope of protection of the invention.

1. A milk frothing device comprising:
a milk tank defining an opening; and
a mixing element, the mixing element configured to be removably attached to the tank at the opening and comprising
a first locking member that can be moved between:
a locked position wherein the first locking member is configured to be received in a first fastening slot formed on the tank, and
an unlocked position wherein the first locking member is configured to be extracted from the first fastening slot, and
wherein the mixing element further comprises at least a second locking member configured to engage with a respective second fastening slot formed on the tank.

2. The milk frothing device according to claim 1, wherein when the first locking member is moved between the locked and unlocked positions, the first locking member is configured to be moved relative to the second locking member.

3. The milk frothing device according to claim 1, wherein the tank extends substantially along a central axis that is substantially vertical when the milk frothing device is in use, and wherein the first locking member is moved from the locked position to the unlocked position in a direction substantially perpendicular to the central axis and extending from the first locking member to the second locking member so that the distance between the first locking member and the second locking member is reduced.

4. The milk frothing device according to claim 3, wherein the second locking member is mechanically associated with the first locking member so that moving the first locking member between the locked and unlocked positions results in a corresponding movement of the second locking member between:
a locked position in which the second locking member is designed to be received in the respective second fastening slot, and
an unlocked position in which the second locking member is designed to be extracted from the respective second fastening slot.

5. The milk frothing device according to claim 4, wherein the mixing element comprises, for the second locking member, an arm configured to be rotated relative to the first locking member as the first locking member moves between the locked and unlocked positions; each arm being configured, as the arm rotates, to translationally drive the second each locking member so as to move it between the locked position and the unlocked position.

6. The milk frothing device according to claim 5, wherein the first locking member is moved from the locked position to the unlocked position in a direction extending from the first locking member to the second locking members so that the distance between the first locking member and the second locking member is reduced, and wherein when the first locking member is moved from the locked position to the unlocked position, the arm is configured to move the second locking member towards the first locking member.

7. The milk frothing device according to claim 5, wherein the arm includes a first pivot connection with the first locking member and a second pivot connection with the second locking member, the first and second pivot connections being positioned at opposite ends of the arm.

8. The milk frothing device according to claim 7, wherein for the arm the first and second pivot connections respectively define substantially parallel first and second rotational axes extending in a substantially vertical direction.

9. The milk frothing device according to claim 7, wherein the mixing element includes a main body and in wherein the arm comprises a third pivot connection with the main body, the third pivot connection being positioned between the first and second pivot connections.

10. The milk frothing device according to claim 1, wherein the mixing element includes a main body and wherein the main body comprises, for the second locking member, a projection configured to form a slide connection with the second locking member.

11. The milk frothing device according to claim 10,
wherein the first locking member forms a bearing surface on which a force can be exerted to move the first locking member from the locked position to the unlocked position, and wherein the first locking member has a corresponding lock position return member.

12. The milk frothing device according to claim 10, wherein the first locking member has a sloping edge forming a chamfer configured to engage with an upper edge of the opening when the mixing element is mounted on the tank to move the first locking member to the unlocked position, and wherein the second locking member has a sloping edge forming a chamfer designed to engage with an upper edge of the opening when the mixing element is mounted on the tank to move the second locking member to the unlocked position.

13. The milk frothing device according to claim 1, wherein the mixing element comprises:
a mixing part; and
a hot water/steam inlet port and a main flow duct connecting the hot water/steam inlet port to the mixing part.

14. The milk frothing device according to claim 130, wherein the mixing element comprises:
the main body including the mixing part, the hot water/steam inlet port, the main flow duct and a milk feed duct connected to the main flow duct, and
a cover member for the main body that can be moved relative to the main body between a closed position in which the cover member closes or covers the mixing part and the main flow duct, and an open position in which the mixing part and the main flow duct are open and accessible to allow the mixing part and the main flow duct to be cleaned.

15. A beverage dispensing machine including a hot water/steam dispensing nozzle and the milk frothing device according to claim 1 configured to be connected to the hot water/steam dispensing nozzle, wherein claim 1.
